(19) United States
(12) Patent Application Publication
(10) Pub. No.: US 2007/0154215 A1
(43) Pub. Date: Jul. 5, 2007

(54) Method and apparatus for detecting optical reflections in an optical network

(75) Inventor: Muneer Zuhdi, Lewisville, TX (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Bedford, Inc., Bedford, TX (US)

(21) Appl. No.: 11/326,077

(22) Filed: Jan. 5, 2006

(51) Int. Cl. H04J 14/00

(52) U.S. Cl. 398/67

(57) ABSTRACT

A method and apparatus for detecting optical reflections in an optical network to locate and assess a problem in the optical network without dispatching multiple technicians with different skill sets and equipment. Optical transport components are configured to transmit optical signals. Supervisory components are configured to supervise the optical transport components. An optical reflection detector is configured: (i) to sense reflections of the transmitted optical signals via the optical transport components and (ii) to provide information about the reflections to the supervisory components. The supervisory components may use the information about the reflections to determine the locations and power values of the reflections. The information about the reflections may be stored in a database and tracked over a length of time. The supervisory components may issue an alarm when a metric associated with reflections exceeds a threshold value.

### BACKGROUND OF THE INVENTION

In an optical network, an operator in a central office uses central office equipment to monitor for problems arising in an Optical Distribution Network (ODN). When the operator, for example, sees an alarm condition indicating a problem in the ODN, she dispatches at least two technicians. A first technician troubleshoots the central office equipment, and a second technician troubleshoots the ODN with complex and expensive equipment, such as an Optical Time Domain Reflectometer (OTDR). Thus, the process of troubleshooting the optical network includes dispatching technicians with different skill sets and equipment to determine whether the problem is related to the central office equipment or the ODN.

### SUMMARY OF THE INVENTION

A system in accordance with an embodiment of the present invention includes an optical reflection detector to assist in locating a problem in the optical network. The system may further include optical transport components and supervisory components. The optical transport components may be configured to transmit optical signals along a first optical path. The supervisory components may supervise the optical transport components. The optical reflection detector may (i) sense reflections of the transmitted optical signals via at least a subset of the optical transport components and (ii) provide information about the reflections to the supervisory components. The information about the reflections may be analyzed to determine whether the problem is located at the central office or elsewhere in the ODN. Thus, once the example system indicates to an operator the location of the problem, the operator may dispatch a technician with the certain skills and equipment to resolve the problem.

A method in accordance with another embodiment of the present invention transmits an optical signal along a first optical path via an optical node. Reflections of the optical signal received at the optical node may be directed along a second optical path. Reflections may then be sensed on the second optical path and information about the reflections may be provided.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a network diagram of an exemplary portion of a network in which an Optical Line Terminal (OLT) comprises an integral reflection detector in accordance with one embodiment of the present invention;

FIG. 2A is a network diagram of an exemplary portion of a network in which optical elements are configured to detect reflections in accordance with one embodiment of the present invention;

FIGS. 2B and 2C are network diagrams of exemplary portions of networks in which optical elements are configured to direct reflections to a reflection detector in accordance with embodiments of the present invention;

FIGS. 3 and 4 are example flow diagrams performed by elements of the OLT in accordance with embodiments of the present invention; and

FIG. 5 is a diagram of an exemplary database storing information about the reflections in accordance with one embodiment of the present invention.

### DETAILED DESCRIPTION OF THE INVENTION

A description of preferred embodiments of the invention follows.

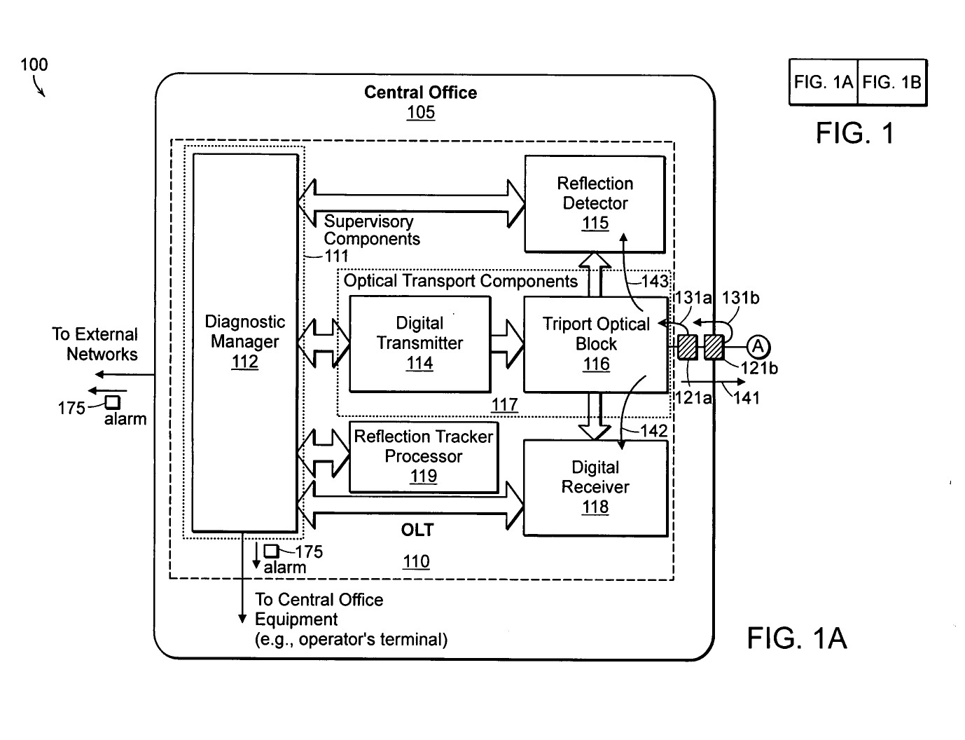

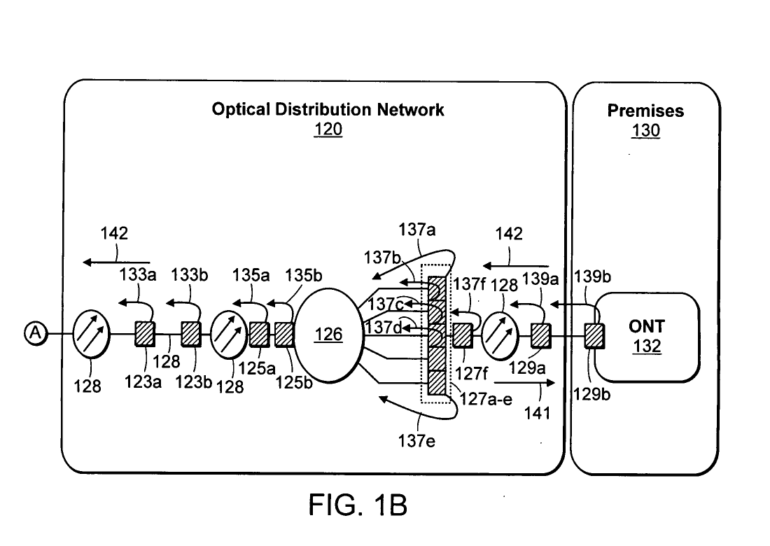

FIG. 1 is a network diagram of an exemplary portion of an optical network 100 in which an embodiment of the present invention may be deployed. An example challenge that operators face in deploying optical networks is optical reflection, typically originating from optical connectors 121a-b, 123a-b, 125a-b, 127a-f, 129a-b, as indicated by arrows 131a-b, 133a-b, 135a-b, 137a-f, 139a-b directed from the optical connectors 121a-b, 123a-b, 125a-b, 127a-f, 129a-b toward a central office 105. In the optical network 100, reflections from optical connectors 127a-f, 129a-b or other optical elements downstream of an optical splitter 126 do not pass upstream through the optical splitter 126 at an intensity sufficient to cause a problem, but transmissions from an Optical Network Terminal (ONT) 132 through the optical connectors 127a-f, 129a-b and other optical elements downstream of the optical splitter 126 will result in return optical reflections (not shown).

In a Fiber-to-the-Premises (FTTP) network 100, depicted in FIG. 1, an optical fiber 128 extends deeper into the network 100 by driving the optical fiber 128 directly to each subscriber's premises 130. This increases the challenges associated with optical reflection caused, for example, by a difference in refractive indices of the optical path on each side of the optical connectors 121a-b, 123a-b, 125a-b, 127a-f, 129a-b. This also introduces other problems that make troubleshooting and maintaining an FTTP network difficult, especially in Passive Optical Networks (PONs) that have an optical splitter 126 because the optical splitter 126 attenuates optical signals passing through it. Many of these problems that arise in an optical network may be very complicated and, thus, may require highly skilled technicians and expensive equipment.

When a problem arises in the exemplary portion of the optical network 100, an alarm 175 may be sent to an operator at the central office 105. The alarm 175 (or alarms) may relate to problems in the physical layer or the Media Access Control (MAC) layer, such as an excessive bit error rate (BER) or power level. In response to certain alarms, the operator may dispatch two technicians, one to check the central office equipment and the other to troubleshoot the ODN with an Optical Time Domain Reflectometer (OTDR), which is costly. Typically, 80% of the time the problem is located in the ODN 120, and 20% of the time the problem is located in the central office 105. As more and more optical fiber is installed, the troubleshooting task may become even more costly.

The exemplary portion of an optical network 100 includes the central office 105 in which an OLT 110 may be deployed. The OLT 110 includes a triport optical block 116, a reflection detector 115, supervisory components 111, a digital transmitter 114, and a digital receiver 118. It should be understood that any or all of the OLT 110 components (e.g., the digital receiver 118) can be included in the triport optical block 116 or similar optical node. The OLT 110 may include other physical layer components, such as a power supply (not shown).

The supervisory components 111 may include a diagnostic manager 112, such as a processor or digital logic, that connects to the reflection detector 115, the digital transmitter 114, and the digital receiver 118. The diagnostic manager 112 may manage information about signals received at the reflection detector 115. The reflection detector 115 and the digital receiver 118 receive signals (e.g., reflections 143 and communications signals 142, respectively), and the digital transmitter 114 transmits signals 141 via the triport optical block 116.

The OLT 110 may connect to other central office 105 equipment (not shown), as indicated in FIG. 1. The central office 105, in turn, may connect to external networks, such as a Public Switched Telephone Network (PSTN) or the Internet (not shown), as indicated in FIG. 1. The digital logic 112, digital transmitter 114, reflection detector 115, triport optical block 116, and digital receiver 118 may be implemented in an FTTP PON card for Broadband PON (BPON) and Giga PON (GPON) applications. The same components may also be implemented on Fiber-to-the-Curb (FTTC) optical interface unit (OIU) cards.

In this embodiment, the triport optical block 116 connects to an Optical Distribution Network (ODN) 120, such as a PON, via a first optical connector 121a. A second optical connector 121b connects to the optical splitter 126 via the optical fiber 128, and the optical connectors 123a-b, 125a-b positioned along the optical fiber 128.

In the example FTTP network, the optical splitter 126 connects to an Optical Network Terminal (ONT) 132 located on a subscriber's premises, via the optical fiber 128 and optical connectors 127a-f, 129a-b. Each optical connector 121a-b, 123a-b, 125a-b, 127a-f, 129a-b may include two components and a bulkhead adapter. The ONT 132 may include the triport optical block 116 and the digital transmitter 114 (collectively referred to as optical transport components 117), and the reflection detector 115 to transmit optical signals and sense reflections of the transmitted optical signals. Accordingly, the optical transport components 117 may be configured to transmit optical signals in either an upstream direction 142 (e.g., from the ONT 132 toward the OLT 110) or a downstream direction 141 (e.g., from the OLT 110 toward the ONT 132).

In operation, according to one embodiment of the present invention, the reflection detector 115 senses optical reflections 131a-b, 133a-b, 135a-b, 137a-f, 139a-b from the Optical Distribution Network (ODN) 120 and provides information about the optical reflections 131a-b, 133a-b, 135a-b, 137a-f, 139a-b to the supervisory components 111. The supervisory components 111 may analyze the information about the optical reflections 131a-b, 133a-b, 135a-b, 137a-f, 139a-b and provide an estimate of the location and magnitude of the reflections 131a-b, 133a-b, 135a-b, 137a-f, 139a-b. The operator may then send a technician with the proper skill set and equipment to the proper location. Thus, a highly skilled technician with an OTDR device may be dispatched when the problem is at certain locations and is highly complex.

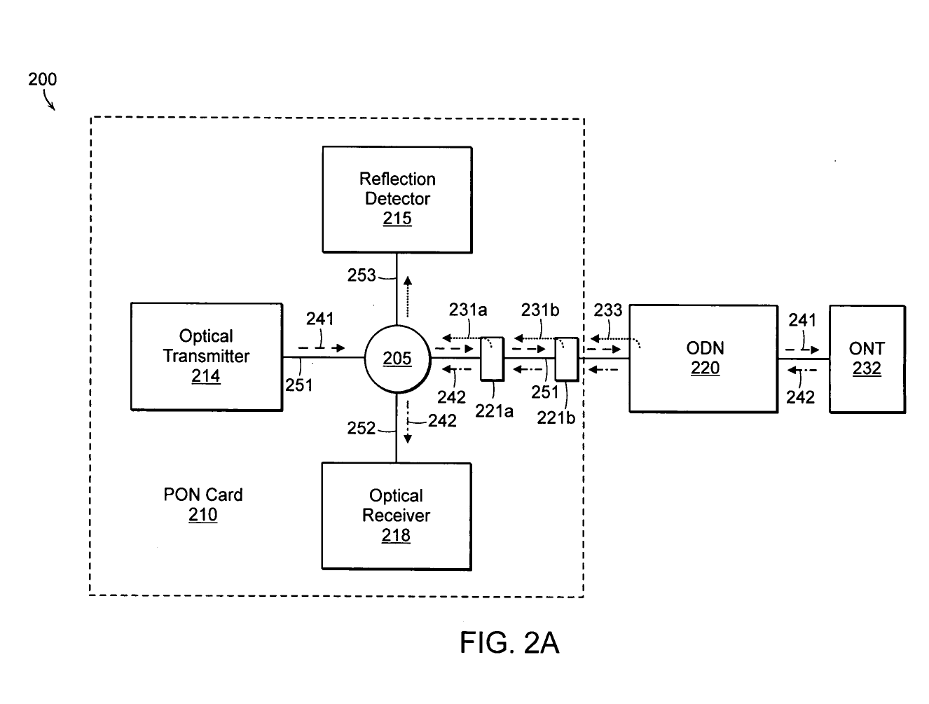

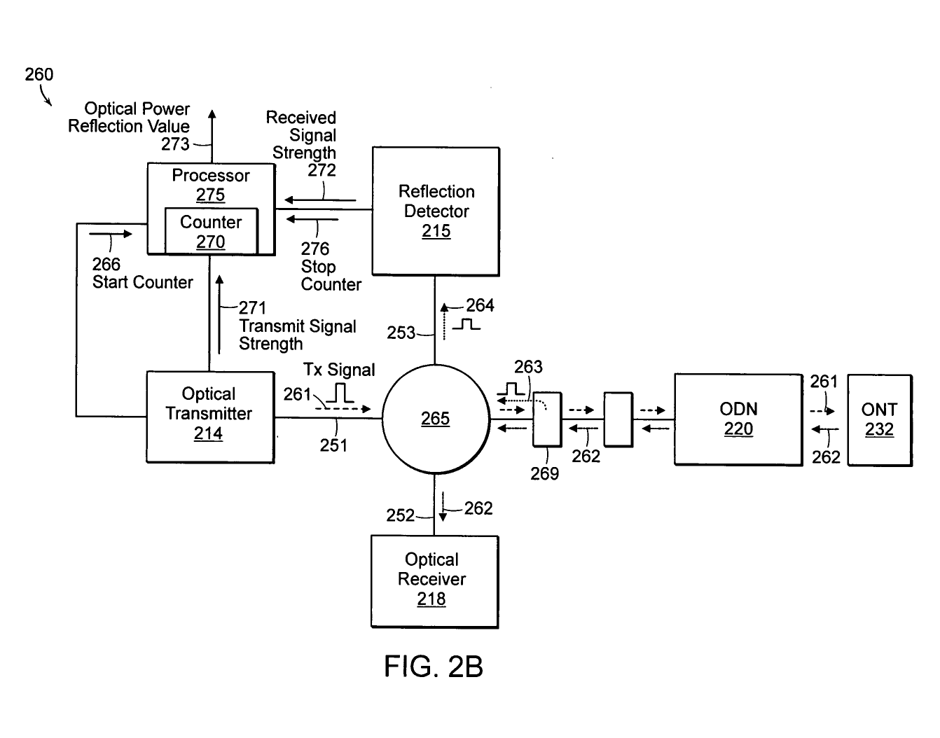

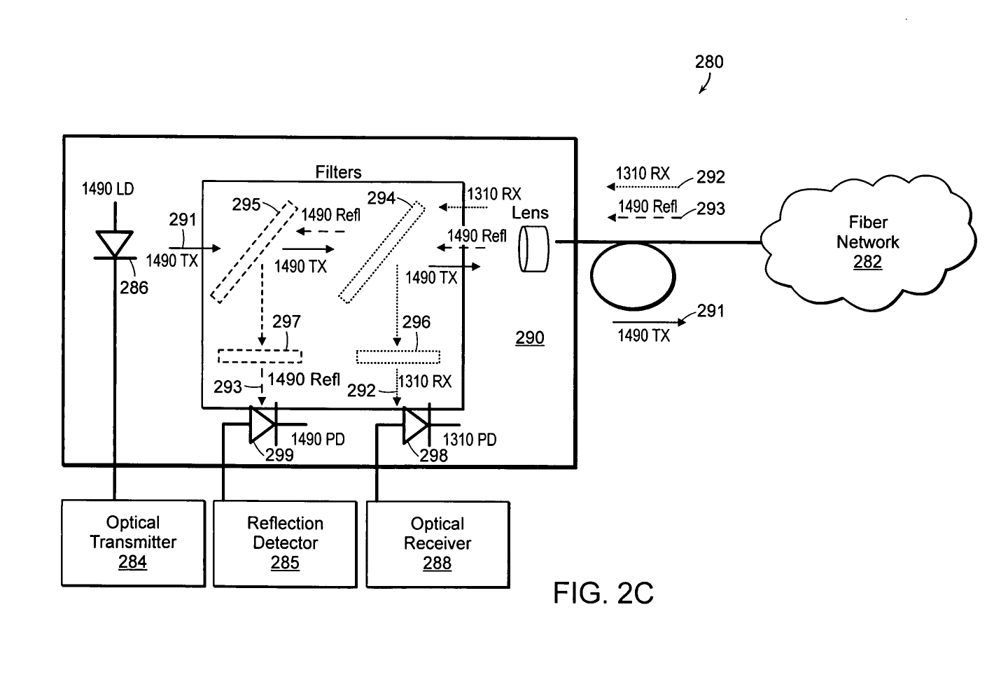

FIG. 2A is a network diagram of an exemplary portion of an optical network 200 in which optical elements are configured to detect reflections in accordance with embodiment(s) of the present invention. An optical transmitter 214 transmits an optical signal 241 along a first optical path 251 via an optical node 205, which may be a beam splitter or other optical component facilitating optical functions described herein or otherwise commonly performed. The optical signal 241 may be a communications or a non-communications optical signal. Reflections 231 a-b, 233 received at the optical node 205 are directed along a second optical path 253. The reflection detector 215 senses the reflections 233, 231a-b on the second optical path 253. Communications optical signals 242 received at the optical node 205 from the ONT 232 are directed along a third optical path 252 to an optical receiver 218.

The reflection detector 215 may sense reflections from an ONT 232, an ODN 220 (or any components of the ODN 220) (i.e., reflection 233), and optical connectors 221a-b (i.e., reflections 231a-b). Information about the sensed reflections may then be provided to supervisory components (not shown) to be analyzed and displayed via a console (not shown) to an operator. The supervisory components may estimate the power (or other metric) and location of the reflections. Thus, the operator can know where to send a certain technician to start troubleshooting an optical network having a problem due to optical reflections. Moreover, based on the power or other metric regarding the optical reflections, other information about the source of the reflection(s) may be gleaned.

According to one embodiment, a PON card 210 including the reflection detector 215 may determine whether the problem due to reflections is located at the ODN 220 or between the optical transmitter 214 and the ODN 220 along the first optical path 251. If the problem is located at the ODN 220, the PON card 210 estimates the location and power (or other metric) of the reflection for each reflection source (e.g., connectors 221a-b). The reflection detector 215 may be implemented in the form of an extra photodiode (not shown) and associated circuitry in the PON card 210. The photodiode may be an Avalanche photodetector or any other photodetector.

FIG. 2B is a network diagram of an exemplary portion of an optical network 260 in which optical elements are configured to direct reflections to a reflection detector in accordance with one embodiment of the present invention. An optical transmitter 214 may generate and transmit a pulse signal 261. At the same time, the optical transmitter 214 may transmit a start signal 266 to a counter 270 in a processor 275 which causes the counter 270 to begin tracking elapsed time. The optical transmitter 214 may also provide a transmit signal strength indicator 271 to the processor 275. The optical node 265 provides a reflection 263 of the pulse signal 261 from a connector 269 to the reflection detector 215 as a reflected pulse signal 264.

When the reflection detector 215 detects the reflected pulse signal 264 directed from the optical node 265, it stops the counter 270 by transmitting a stop counter signal 276 to the processor 275. The reflection detector 215 or associated electronic components may then measure a received signal strength of the reflected pulse signal 264 and provide a received signal strength signal 272 to the processor 275. The processor 275 may combine the received signal strength signal 272 and the transmit signal strength signal 271 into a received signal relative to transmit signal strength indicator value. The processor 275 may thereafter translate the received signal relative to transmit signal strength indicator value into an optical power reflection value 273.

FIG. 2C shows an embodiment of an optical node 290 in an exemplary portion of a network 280. The optical node may include an optical transmitter 284 and a laser diode 286 that transmit a transmit signal 291, such as a transmit signal having a 1490 nm wavelength, in a downstream direction towards a fiber network 282.

The optical node 290 may also include optical filters, such as first and second transmissive/reflective filters 294, 295 and first and second optical filters 296, 297. The first transmissive/reflective filter 294 may include a glass substrate with an optical coating, such as a dielectric. The first transmissive/reflective filter 294 reflects wavelengths of a “receive” communications signal 292 to the first optical filter 296. The “receive” communications signal 292 may be an upstream communications signal having a 1310 nm wavelength and traveling in a direction away from a fiber network 282. The first optical filter 296 may be a bandpass filter that allows the “receive” communications signal to pass to a first photodiode 298, which provides a corresponding electrical signal (not shown) to the optical receiver 288.

In this embodiment, the first transmissive/reflective filter 294 allows transmission of the transmit signal 291 in a downstream direction towards the fiber network 282. Also in this embodiment, the first transmissive/reflective filter 294 allows transmission of a reflected signal. 293, such as a reflection of the transmit signal 291 having a 1490 mn wavelength, in an upstream direction towards the second transmissive/reflective filter 295.

The second transmissive/reflective filter 295 may also include a glass substrate with an optical coating. In this embodiment, the second transmissive/reflective filter 295 reflects wavelengths of the reflected signal 293 to the second optical filter 297. The second optical filter 297 may be a bandpass filter that allows the reflected signal 293 to pass to a second photodiode 299, which provides a corresponding electrical signal to the reflection detector 285. In this embodiment, the second transmissive/reflective filter 295 also allows transmission of the transmit signal 291 in a downstream direction towards the fiber network 282.

The configuration of FIG. 2C allows for a real-time mode or a maintenance mode. In the real-time mode embodiment, the source of the reflected signal 293 is the downstream communications transmit signal 291 itself. Thus, optical filter pairs 294/296, 295/297 are designed to facilitate simultaneous communications and reflection detection. It should be understood that the optical filters may need to be of high enough quality to filter closely spaced wavelengths (e.g., 1490 and 1310 nm) in a manner as described above. Because the source of the reflected signal 293 is the downstream communications transmit signal 291 from the optical transmitter 284, a separate diagnostics optical transmitter is not needed in the real-time mode embodiment.

Alternatively, in maintenance mode, communications are disabled so that only the reflected signal 293 is provided to the optical node 290 in the upstream direction. In this embodiment, one optical filter pair (e.g., 294/296 or 295/297) may be used at a time or another optical arrangement may be employed. Thus, lower quality filters may be employed because the optical filters do not have to discriminate between two or more signals with closely spaced wavelengths (e.g., a 1310 nm “receive” communications signal 292 and a 1490 nm reflected signal 293 ). A filter wheel or other means for switching the optical filters for supporting maintenance mode or normal communications mode may be integrated into the optical node 290.

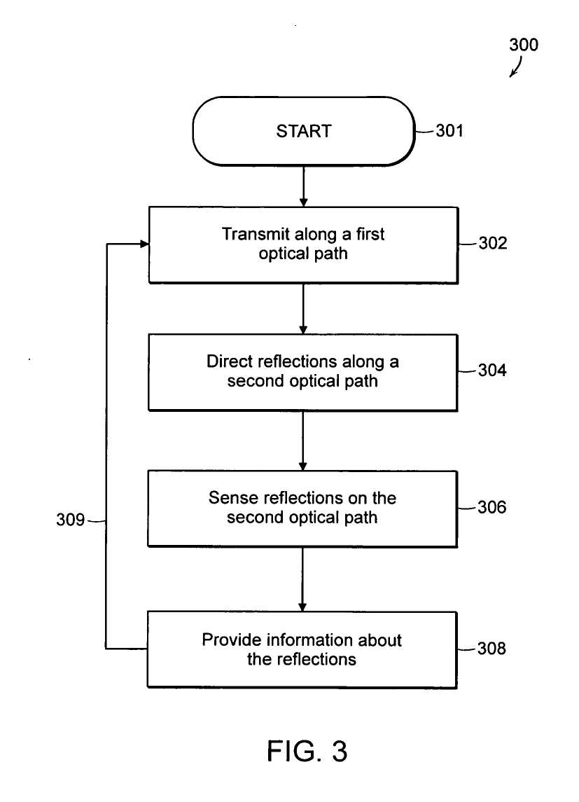

FIG. 3 is an example flow diagram 300 performed by elements of the OLT 110 (FIG. 1). After starting (301), an optical transmitter transmits an optical signal (302) along a first optical path. An optical element directs reflections (304) along a second optical path. An optical reflection detector senses reflections (306) on the second optical path. A processor provides information (308) about the reflections. The information about the reflections may be provided directly to the operator via a console or may be processed by another processor. The flow diagram may return (309) to transmit optical signals (302) along a first optical path.

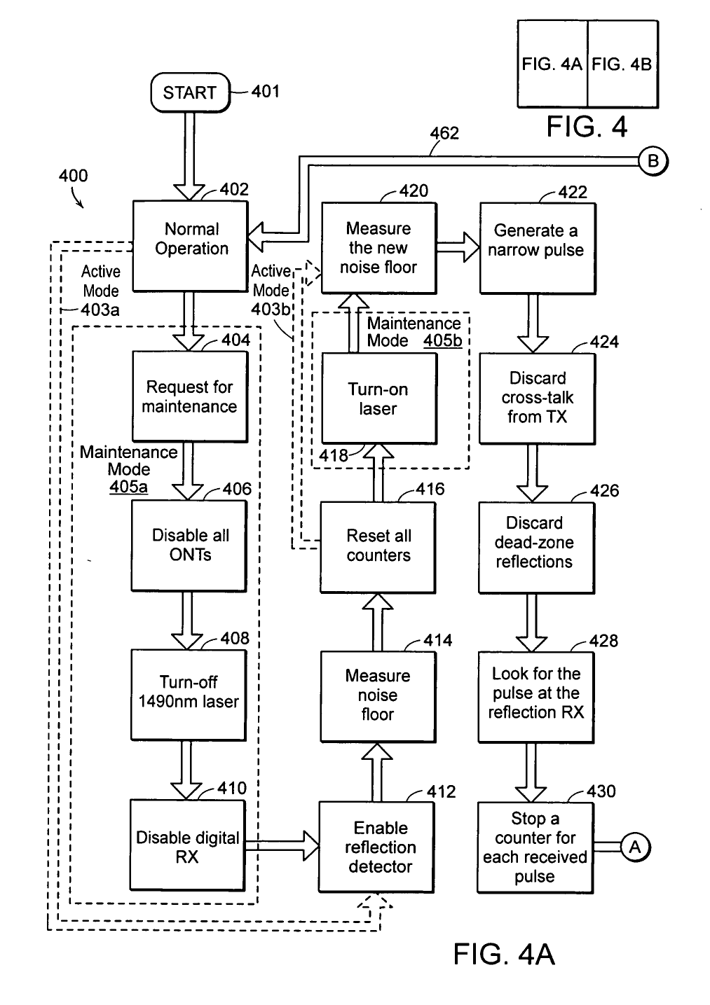

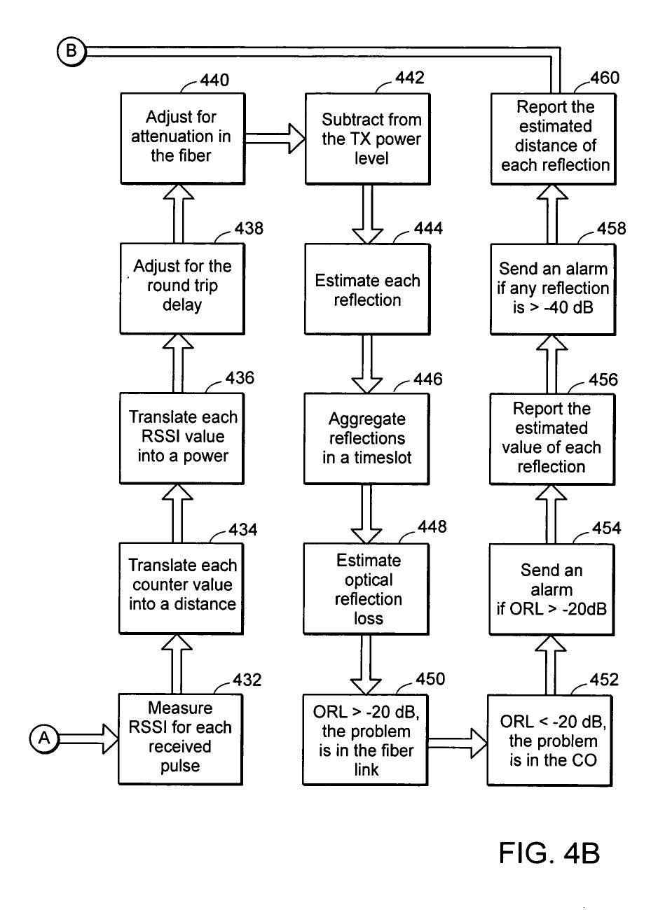

FIG. 4 is another example flow diagram 400 performed by elements of the OLT 110 (FIG. 1) (e.g., an OLT PON card). After starting (401), the OLT operates normally (402). In a maintenance mode embodiment (405a), the OLT receives a request (404) for maintenance. First, in response to this request, the OLT disables all ONTs (406) so that there is no interference from the ONTs'lasers. Second, the OLT turns off its transmitting laser (408), such as a 1490 nanometer (nm) laser, to measure the noise floor at a reflection detector. Third, the OLT disables the digital receiver (410) (e.g., digital receiver 118 in FIG. 1). Alternatively, the OLT may operate in a real-time or active mode. In active mode, the OLT bypasses (403a) the maintenance mode operations (404-410). Then, in both modes, the OLT enables the reflection detector (412), measures the noise floor (414), and resets at least one counter (416) allocated, for example, by the OLT's supervisory components for each reflection source (e.g., optical connectors). Each counter determines a length of time for each reflection to be received at the reflection detector after the OLT's optical transport components transmit optical signals along an optical path.

Next, in maintenance mode (405b), the OLT turns on a laser (418). In active mode, however, the OLT bypasses (403b) this maintenance mode operation. Then, in both maintenance mode and active mode, the OLT measures the new noise floor (420). At this point, the OLT may generate a narrow pulse (422). In other embodiments, different signals may be generated, including a communications signal. After transmitting an optical signal, the OLT may discard crosstalk (424) between the OLT's laser (e.g., a 1490 nm laser) and the reflection detector's photodiode (e.g., a 1490 nm photodiode) by applying a bias current to the OLT's laser, measuring crosstalk, and subtracting out the crosstalk. A dead-zone appears due to near-end crosstalk and reflections inside a central office. Thus, the OLT may discard dead-zone reflections (426).

After discarding dead-zone reflections, the OLT looks for reflections (428) from the generated and transmitted narrow pulse (or any other signal) through its reflection detector. All reflections from the ODN appear at the reflection detector as delayed pulses at much lower power levels. The OLT stops each counter (430) when each pulse is received. The OLT may then measure a received signal relative to transmit signal strength indicator (432) (or a received signal strength indicator) for each received pulse. The OLT may translate each counter value (434) into a round trip travel time, which, in turn, may be mapped into a distance. This distance determines the location of each reflection source. The OLT may also translate each received signal relative to transmit signal strength indicator value (436) into an optical received power reflection value or pulse. The OLT may also adjust the optical received power value for the round trip delay (438) and attenuation in the fiber (440). The fiber attenuation for any given laser wavelength, such as a 1490 nanometer (nm) wavelength, is well known in the art.

The OLT subtracts the received power reflection value from the transmitted power value (442) of the OLT's laser, which may be stored in the memory of the diagnostic manager. Then, the OLT estimates the reflection value (444) of each reflector based on: (i) the optical received power for each pulse, (ii) the approximate location of each reflector, and (iii) the optical transmit power value. The OLT also aggregates reflections (446) that raise the noise floor in a certain time slot in order to estimate the amount of the total optical return loss (448). If the optical reflection loss (ORL) is greater than a predetermined value, such as −20 dB, the OLT determines that a problem exists somewhere in the ODN (450). If, on the other hand, the ORL is less than the predetermined value, the OLT determines that a problem exists somewhere in the central office (452). The OLT may also estimate other metrics associated with reflections.

If the ORL is greater than the predetermined value, then the OLT sends an alarm (454) to the operator so that the operator may dispatch a technician to troubleshoot the ODN. If any of the reflections are greater than another predetermined value, such as −40 dB, then the OLT sends another alarm (458) to the operator. The OLT may then report: (i) the estimated value of each reflection (456) and (ii) the estimated distance of each reflection (460) to the operator through, for example, the diagnostic manager. Finally, the OLT returns (462) to normal operation (402).

In maintenance mode 405, the OLT may report an estimate of the location and the amount of the reflection for each reflector during a given window of time. This may help the operator determine whether or not the problem is in the ODN before dispatching any technicians.

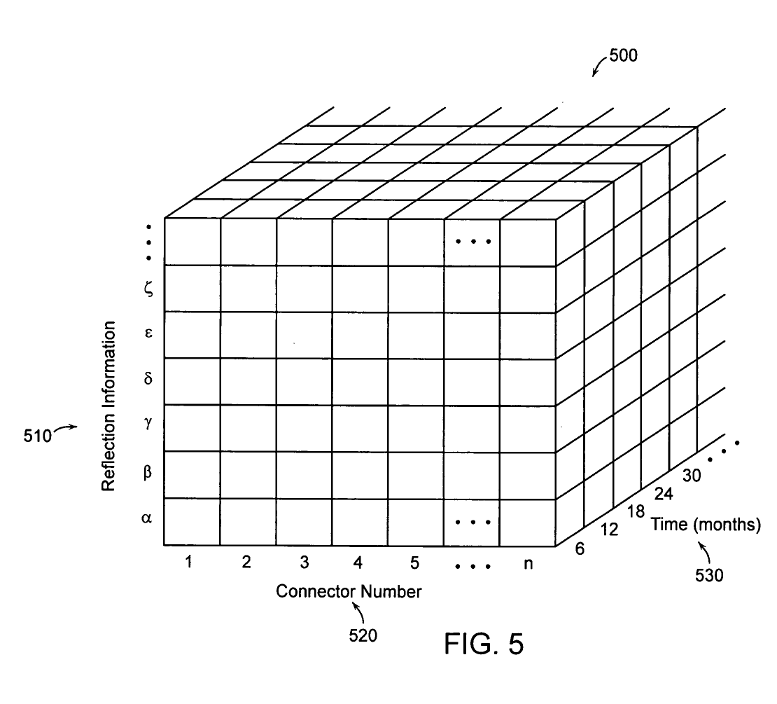

FIG. 5 is a diagram of an exemplary database 500 (depicted as three-dimensional cells) storing information about the reflections. The database 500 may have three axes: reflection information 510, connector number 520, and time 530 in months. Other units of measure, other scale values, fewer axes, or additional axes may also or alternatively be used.

In operation, for each connector number 520 and each time slot 530, the database 500 may store reflection information 510, such as the actual reflection power level a (e.g., in units of dB), the distance to each connector P (e.g., in units of kilometers), and so forth. In this way, information about the reflection sources in the ODN may be tracked over a length of time (e.g., six month intervals) by a “reflection tracker” processor 119 (optionally included in the diagnostic manager 112 or reflection detector 115 in FIG. 1) in order to monitor degradation in ODN reflector performance. The supervisory components, such as the diagnostic manager 112, may be configured to communicate with the database 500. The reflection tracker processor 119 may issue an alarm or otherwise report information if it observes that a threshold has been exceeded.

While this invention has been particularly shown and described with references to preferred embodiments thereof, it will be understood by those skilled in the art that various changes in form and details may be made therein without departing from the scope of the invention encompassed by the appended claims.

For example, in some embodiments, the reflection detector 115, 215 may be deployed in an ODN or ONT. In that way, downstream or upstream reflections may be sensed, reported (optionally via the optical links), compared, or otherwise handled to add to database(s) or knowledge of a service provider, equipment manufacturer, optical connector manufacturer or distributor, or so forth. Although presented in the context of an optical network, it should be understood that the principles of the present invention may be applied to wired or wireless networks.

Embodiments of the system, or corresponding method, may generate an alarm signal in an event a percentage change in a metric associated with the reflections over time exceeds a predetermined threshold percentage value. Other parameters associated with the reflections may cause supervisory components to issue an alarm signal.

The reflection detector 115 of FIG. 1 may provide information about the reflections to the diagnostic manager 112 or may alternatively provide the information to another processor, operator console, or communications network via other network path(s), such as a wired, wireless, or optical network(s) other than shown.

The optical transmitter 214 of FIG. 2 may transmit optical communications signals, such as on carrier wavelengths in the 1550 nm window (i.e., 1480 nm to 1560 nm) whose reflections are detected by the reflection detector 215. Alternatively, the optical transmitter 214 may transmit non-communications signals, such as out-of-band optical signals in both the upstream or downstream directions. In this way, the system can assess network operations in a real-time manner or in a maintenance mode. In some embodiments, the maintenance mode optical signal (i.e., out-of-band) may be transmitted at the same time as the communications signal.

Further, aspects of the flow diagrams of FIGS. 3 and 4 may be implemented in software, firmware, or hardware. In the case of software, software instructions may be stored on a computer-readable medium, such as RAM, ROM, CD-ROM, or the like, and be loaded and executed by a processor adapted to be configured to perform methods described herein or otherwise applicable to reflection detection, informing operators, sending alarms, and so forth.

What is claimed is:

1. A system in an optical network, comprising:
optical transport components configured to transmit optical signals in an optical path;
supervisory components configured to supervise the optical transport components; and
an optical reflection detector configured to sense reflections of the optical signals via at least a subset of the optical transport components and to provide information about the reflections to the supervisory components.

2. The system according to claim 1 wherein the optical reflection detector is configured to sense reflections during times the optical transport components transmit non-communications optical signals in the optical path.

3. The system according to claim 1 wherein the optical reflection detector is configured to sense reflections during times the transport components transmit communications optical signals in the optical path.

4. The system according to claim 1 further comprising a reflection tracker processor configured to communicate with the supervisory components and to track information about the reflections over a length of time, wherein the reflection tracker processor provides information or issues an alarm to the supervisory components if the reflections exceed a threshold.

5. The system according to claim 1 further comprising a filter configured to filter downstream and upstream wavelengths and to direct wavelengths known to include the reflections to the optical reflection detector.

6. The system according to claim 1 wherein the optical reflection detector includes at least one counter used to determine a length of time for reflections to be received after the optical signals are transmitted in the optical path.

7. The system according to claim 1 wherein the reflections are defined by reflection pulses and further including a receiver configured to determine a received signal relative to a transmit signal strength indicator value of the reflection pulse.

8. The system according to claim 7 further comprising a processor that converts the received signal relative to the transmit signal strength indicator value into a corresponding optical power reflection value.

9. The system according to claim 7 wherein the supervisory components convert the received signal relative to the transmit signal strength indicator value into a corresponding optical power reflection value.

10. The system according to claim 1 wherein the supervisory components comprise a diagnostic manager configured to manage information regarding at least a subset of information about the reflections.

11. The system according to claim 10 further comprising a table of reflections, accessible to the diagnostic manager, that stores information corresponding to reflection sources known to be in a reflection time window in the optical path.

12. The system according to claim 1 wherein the optical transport components are configured to transmit the optical signals in a downstream direction or in an upstream direction.

13. The system according to claim 1 wherein the supervisory components are configured to generate an alarm in an event a metric associated with the reflections exceeds a threshold value or a threshold percentage value.

14. The system according to claim 1 wherein the optical transport components are disposed in an Optical Line Terminal (OLT) or an Optical Network Terminal (ONT).

15. A method of troubleshooting an optical network, comprising:
transmitting an optical signal along a first optical path via an optical node;
directing reflections of the optical signal received at the optical node along a second optical path;
sensing the reflections on the second optical path; and
providing information about the reflections.

16. The method according to claim 15 wherein sensing reflections comprises sensing reflections during times of transmitting non-communications optical signals along the first optical path.

17. The method according to claim 15 wherein sensing reflections comprises sensing reflections during times of transmitting communications optical signals along the first optical path.

18. The method according to claim 15 further comprising tracking the information about the reflections over a length of time and providing information about the reflections or issuing an alarm if the reflections exceed a threshold.

19. The method according to claim 15 further comprising filtering downstream and upstream wavelengths and directing wavelengths known to include the reflections along the second optical path.

20. The method according to claim 15 further comprising determining a length of time between transmitting the optical signal along the first optical path and sensing the reflections on the second optical path.

21. The method according to claim 15 wherein the reflections are defined by reflection pulses and further comprising determining a received signal relative to a transmit signal strength indicator value for each of the reflection pulses.

22. The method according to claim 21 further comprising converting the received signal relative to the transmit signal strength indicator value, into a corresponding optical power reflection value.

23. The method according to claim 15 further comprising managing at least a subset of information about the reflections.

24. The method according to claim 23 further comprising storing information corresponding to reflection sources known to be in a reflection time window in the first optical path.

25. The method according to claim 15 wherein transmitting the optical signal comprises transmitting the optical signal in a downstream direction or in an upstream direction.

26. The method according to claim 15 further comprising generating an alarm in an event a metric associated with the reflections exceeds a threshold value or a threshold percentage value.
